(19) United States
(12) Patent Application Publication
(10) Pub. No.: US 2017/0063853 A1
(43) Pub. Date: Mar. 2, 2017

(54) DATA CIPHER AND DECIPHER BASED ON DEVICE AND DATA AUTHENTICATION

(71) Applicant: Infineon Technologies AG, Neubiberg (DE)

(72) Inventor: Cheow Guan Lim, Singapore (SG)

(21) Appl. No.: 14/796,892

(22) Filed: Jul. 10, 2015

(51) Int. Cl. H04L 29/06

(52) U.S. Cl. CPC H04L 63/0876; H04L 63/123; H04L 63/0457

(57) ABSTRACT

A device is described that determines a session key for generating a message authentication code (MAC) tag associated with a communication session between the device and a second device. The device determines, based at least in part on the session key, a crypto key for encoding or decoding a message associated with the second device. The device then encodes or decodes the message based on the crypto key.

### BACKGROUND

Some devices take steps to ensure the integrity of the data received from another device, as well as the authenticity of the data, by performing message authentication code (MAC) techniques, such as the techniques described in U.S. Pat. No. 8,630,411 to Lim et al MAC techniques may enable a recipient device to implement a challenge-response protocol for authenticating a source device and for confirming that data. received from the source device has not been manipulated or otherwise altered, from original form.

In some instances, the data received from an authenticated source may include valuable and/or sensitive information (e.g., passwords, proprietary secrets, personal information, or other sensitive information). Even though MAC techniques may enable a recipient device to ensure data integrity, MAC techniques may do nothing to protect the actual data being transferred from being intercepted by an unauthorized device. As such, the data may be susceptible to attack from unauthorized sniffer devices that snoop or otherwise listen in on the data exchange in an attempt to obtain access to the valuable and/or sensitive information being shared in the exchange.

To protect against illicit snooping, some devices may execute complex cryptographic algorithms and perform complicated operations to encode data before transmission and decode the data upon receipt. Executing complex cryptographic algorithms to encode and decode data may be too complex or too expensive for some low-cost or less complicated systems.

### SUMMARY

In one example, the disclosure is directed to a method that includes determining, by a first device, a session key for generating a message authentication code (MAC) tag associated with a communication session between the first device and a second device, determining, by the first device, based at least in part on the session key, a crypto key for coding a message associated with the second device, and coding, by the first device, based on the crypto key, the message.

In another example, the disclosure is directed to a first device that includes at least one processor operable to determine a session key for generating a message authentication code (MAC) tag associated with a communication session between the first device and a second device, determine, based at least in part on the session key, a crypto key for encoding or decoding a message associated with the second device, and code, based on the crypto key, the message.

In another example, the disclosure is directed to a system that includes means for determining a session key for generating a message authentication code (MAC) tag associated with a communication session between a first device and a second device, means for determining, based at least in part on the session key, a crypto key for encoding or decoding a message associated with the second device, and means for coding, based on the crypto key, the message.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example system for exchanging encoded data between two authenticated devices, in accordance with techniques of this disclosure.

FIG. 2 is a conceptual diagram illustrating an additional example system for exchanging encoded data between two authenticated devices, in accordance with techniques of this disclosure.

FIGS. 3A and 3B are flow charts illustrating example operations performed by example devices for coding data, in accordance with one or more aspects of the present disclosure.

FIG. 4 is a conceptual diagram illustrating an example data stream being transferred between two authenticated devices, in accordance with one or more aspects of the present disclosure.

FIG. 5 is a conceptual diagram illustrating an additional example system for exchanging encoded data between a single host device and two separate slave devices, in accordance with techniques of this disclosure.

FIG. 6 is a conceptual diagram illustrating authentication flow for exchanging encoded data between two authenticated devices, in accordance with techniques of this disclosure.

FIG. 7 is a conceptual diagram illustrating an additional example system for exchanging encoded data between two authenticated devices, in accordance with techniques of this disclosure.

FIG. 8 is a conceptual diagram illustrating example pseudo code for execution by one the two authenticated devices of the example system of FIG. 7 to perform operations for coding data, in accordance with one or more aspects of the present disclosure.

FIG. 9 is a flow chart illustrating example operations performed by one the two authenticated devices of the example system of FIG. 7 when executing the example pseudo code of FIG. 8, in accordance with one or More, aspects of the present disclosure.

### DETAILED DESCRIPTION

In general, circuits and techniques are described for enabling devices to encode information being exchanged between devices that utilize message authentication code (MAC) techniques for verifying the integrity and authenticity of the information, without requiring either device to pre-store, or exchange, a password or decryption key. For example, as a way to ensure data integrity, a first device and a second device may implement a challenge-response protocol according to the techniques described in U.S. Pat. No. 8,630,411 to Lint et al.

As part of implementing the challenge-response protocol, the first device and the second device may each derive a session key that is common to both the first and second devices but never actually shared across the communication line. When receiving data front the first device, the second device may authenticate the first device by inputting the session key into a MAC algorithm to derive an instance of a MAC tag. The second device may compare the derived MAC tag to a MAC tag received from the first device along with the data transmission. If the derived and received MAC tags match, the second device may “authenticate” the first device (e.g., confirm the identity of the first device) and verify the integrity of the received data (e.g., confirm that the data was unaltered during transmission).

To encode and protect the data being exchanged by two authenticated devices from illicit snooping (e.g., by a third-party or otherwise unauthorized device), the first and second devices may go beyond performing authentication and data integrity operations and may utilize the derived session keys to encode and decode the data before and after transmission. For example, prior to transmission to the second device, the first device may encode the data using the derived session key as a “cipher” or “encryption key” to scramble the data and prevent unauthorized access. In some examples, the first device may encode data prior to transmission by performing an “exclusive-or” (also referred to as “XOR” or “exclusive disjunction) operation between the derived session key and the data. After receipt of the data, the second device may then decode the data using the derived session key as a “decipher” or “decryption key” to unscramble the data. In some examples, the second device may decode the data after receipt by performing an exclusive-or operation between the encoded data and the derived session key to obtain the original, unencoded data.

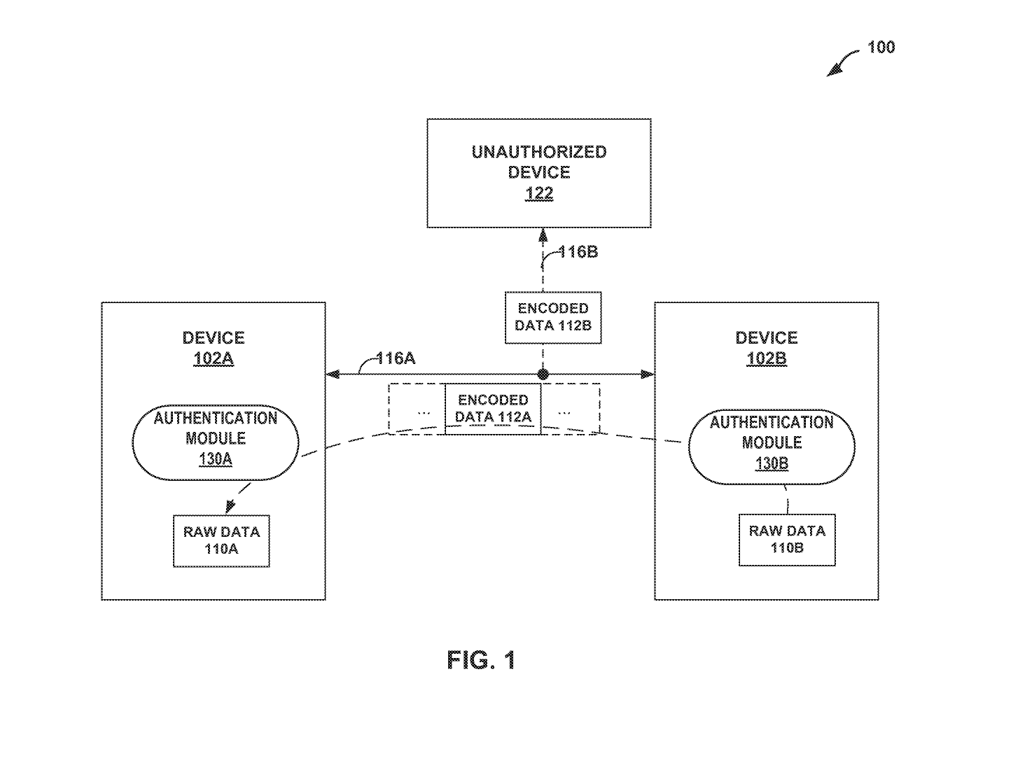

FIG. 1 is a conceptual diagram illustrating system 100 as an example system for exchanging encoded data between two authenticated devices 102A and 102B, in accordance with techniques of this disclosure. System 100 includes device 102A and device 102B (collectively “devices 102”) which are configured to exchange information (e.g., data) via communication channel or “link” 116A. System 100 also includes unauthorized device 122 which is configured to intercept, via link 116B, the data being exchanged across link 116A.

Unauthorized device 122 represents any type of device that is configured to sniff, snoop, or otherwise intercept information being exchanged via a data path. Examples of unauthorized device 122 include computing devices, computing systems, network devices, or any other type of device that can read data being passed between devices via a data path. In the example of FIG. 1, unauthorized device 122 may receive, via link 116B, a copy of the information or data traveling between devices 102 via link 116A. In instances when the data transmitted across link 116A is unencoded, unauthorized device 122 can interpret the information encoded in the data received via link 116B. Conversely, in instances when the data transmitted across link 116A is encoded, unauthorized device 122 may be unable to interpret (e.g., at least without performing additional operations to decode the data) the information encoded in the data received via link 116B.

Devices 102 represent any type of devices that are configured to exchange information via a data path. For example, devices 102 include any combination of a mobile computing devices, wearable computing devices, personal digital assistants (PDAs), cameras, audio players, gaming systems or consoles, audio and/or video systems, other entertainment devices, desktop or laptop computers, computer systems, network or computing devices, copy machines, scanners, all-in-one or other digital imaging or reproduction devices, medical devices or equipment or diagnostic supplies, automobiles or automotive systems, aerial vehicles (both manned and unmanned air vehicles) or aerial vehicle systems, marine vehicles or marine systems, aerospace and military vehicles or aerospace and military systems, industrial components or industrial systems, or sonic other part, accessory, or component, battery, accessory devices, earphone devices, headset devices, speaker devices, docking stations, game controller devices, charging devices, microphone devices, toner cassette devices, magazine devices, network device, peripheral devices, internal or external storage devices, or any other devices or components for which authentication and secure data transmission is required.

Device 102A includes authentication module 130A and device 102B includes authentication module 130B. Authentication module 130A and 130B (collectively “authentication modules 130”) may enable devices 102 to execute a challenge-response protocol for authenticating devices 102 and ensuring integrity of the data being exchanged over link 116A, and may further use a session key derived from the execution of the challenge-response protocol to encode and decode the data being exchanged over link 116A (e.g., to prevent intrusion by unauthorized device 122)

Authentication modules 130 may comprise any suitable arrangement of hardware, software, firmware, or any combination thereof, to perform the techniques attributed to authentication modules 130 that are described herein. For example, authentication modules 130 may each include any one or more microprocessors, digital signal processors (DSPs), application specific integrated circuits (ASICs), field programmable gate arrays (FPGAs), Of any other equivalent integrated or discrete logic circuitry, as well as any combinations of such components. When authentication modules 130 include software or firmware, authentication modules 130 further includes any necessary hardware for storing and executing the software or firmware, such as one or more processors or processing units.

In general, a processing unit may include one or more microprocessors, DSPs, ASICs, FPGAs, or any other equivalent integrated or discrete logic circuitry, as well as any combinations of such components. Although not shown in FIG. 1, authentication modules 130 may include a memory configured to store data. The memory may include any volatile or non-volatile media, such as a random access memory (RAM), read only memory (ROM), non-volatile RAM (NVRAM), electrically erasable programmable ROM (EEPROM), flash memory, and the like. In some examples, the memory may be external to authentication modules 130 e.g., may be external to a package in which authentication modules 130 are housed.

In operation, as described in U.S. Pat. No. 8,630,411 to Lim et al., authentication modules 130A and 130B may together implement a challenge-response protocol for authenticating devices 102 and ensuring integrity of the data being exchanged over link 116A. For example, during a particular communication session, device 102B may transmit data to device 102A via link 116A. So that device 102A can verify that the data received via link 116A has arrived unaltered and actually originated from device 102B, authentication module 130B of device 102B may derive a first instance of a session key for the particular communication session between devices 102, The first instance of the session key may be regenerated by authentication module 130B for each communication session (e.g., periodically, etc.)

Based on the derived first instance of the session key, authentication module 130B may then generate a first message authentication code (MAC) tag for the particular communication session and include the first MAC tag within the data that device 102A outputs to link 116A. For example, authentication module 130B may input the session key into a MAC function that outputs a first MAC tag which authentication module 130B then uses to mark the data before transmission.

Upon receipt of data from link 116A, authentication module 130A of device 102A may analyze the first MAC tag with the data received via link 116A to determine whether device 102B actually transmitted the data and further whether the data is unaltered from its original form. For instance, authentication module 130A of device 102A may derive a second instance of the session key for the particular communication session between devices 102. The second instance of the session key may be regenerated by authentication module 130A for each communication session (e.g., periodically, etc.)

In some examples, the first and second instances of the session keys may be regenerated based on the amount of data transferred between devices. For example, the first and second instances of the session keys may be regenerated by devices 102 after a certain quantity of bytes (e.g., one thousand twenty-four bytes or some other quantity of data) have passed over link 116. In other examples, devices 102 use time as a variable for determining when to derive updated session keys. For instance, devices 102 may determine updated session keys after a certain amount of time (e.g., one second, one hour, or other time increment) has elapsed since the session keys were last derived.

Based on the derived second instance of the session key, authentication module 130A may then generate a second MAC tag for the particular communication session and determine whether the second MAC lag that authentication module 130A generates matches the first MAC tag received within the data received via link 116A. For example, authentication module 130A may input the session key into a MAC function that outputs a second MAC tag which authentication module 130A then uses to verify whether the data received via link 116A is authentic or not. Authentication module 130A may determine that the data received via link 116A is authentic if the second MAC tag generated by authentication module 130A matches the first MAC tag received within the received data.

To prevent snooping of the information contained within the data exchanged via link 116A, authentication modules 130A and 130B may encode and decode the data prior to transmission and subsequent to receipt. However, unlike some devices that protect against illicit snooping by executing complex cryptographic algorithms and perform complicated operations to encode and decode data, authentication modules 130A and 130B derive crypto keys based on the same session keys already generated for authentication purposes to encode and decode the data. In other words, authentication modules 130A and 130B reuse the derived session keys, with or without performing minor variations, to generate crypto keys for ciphering data before transmission and deciphering data upon receipt. In some examples, authentication modules 130A and 130B may regenerate a separate set of derived session keys that are not for MAC tag usage. In other cases, authentication modules 130A and 130B derives a second session keys and use them together with the previous session keys. The second session keys are used for ciphering the data before the transmission and deciphering data upon receipt. The MAC tag can be performed before or after the ciphering or deciphering of the data. In other cases, more session key pair can be prepared for data with ciphering and deciphering with many keys.

For example, authentication module 130B may produce encoded data 112A for transmission to device 102A by performing an exclusive-or operation (or some other ciphering technique) between raw data 110B and a crypto key that corresponds to, or is at least based on, the same session key that authentication module 130B derived for generating the first MAC being used for the particular communication session. In other examples, the crypto key represents a digest of the session key and a seed value (e.g., a random number, a number based on time of day, etc.) shared between devices 102.

In some examples, authentication module 130B encodes both raw data 110B and the associated MAC to produce encoded data 112A. In other examples, authentication module 130B encodes just raw data 110B to produce encoded data 112A.

In any case, device 102B outputs encoded data 112A to link 116A rather than raw data 110B. Because encoded data 112A is a scrambled version of raw data 110B, unauthorized device 122 may be unable to interpret the information contained within encoded data 112A.

Authentication module 130A may unscramble encoded data 112A received via link 116B into raw data 110A by performing an exclusive-or operation (or some other de-cyphering technique that reverses the cyphering performed by authentication module 130B) between encoded data 112A and the crypto key that corresponds to, or is at least based on, the same session key that authentication module 130A derived for the second MAC being used for the particular communication session. In other examples, the crypto key represents a digest of the session key and a seed value (e.g., a random number, a number based on time of day, etc,) shared between devices 102. Authentication module 130A may store the unscrambled version of encoded data 112A at device 102A as raw data 110A.

In this way, devices that encode and decode data in accordance with the techniques described herein may protect against illicit snooping without having to execute complex cryptographic algorithms or perform complicated operations to encode data before transmission and decode the data upon receipt. By producing crypto keys to encode and decode data based at least in part on session keys that were already being derived for authentication purposes, the techniques described in this disclosure may enable low-cost or less complicated systems exchange information without being susceptible to snooping.

In some examples, devices 102 may be part of an unmanned air vehicle application. For example, device 102A may be an unmanned air vehicle and device 102B may be a controller or ground station for controlling the unmanned air vehicle. Device 102B may send control instructions for that device 102A uses for flying a glide path to a target location. By ciphering and deciphering the control instructions, before and after transmission, devices 102 can ensure that the control instructions do not interfere with the operations of other unmanned air vehicles in the area. In other examples, the information shared between unmanned air vehicle 102A and controller 102B may include data indicating the pick-up and drop-off location for goods being delivered by unmanned air vehicle 102A. In other examples, the information may include data indicating the control operations, or redirection or cancelation of the delivery of the goods.

In some examples, device 102A may be a transmitter associated with a sender of goods using an unmanned air vehicle and device 102B may be a receiver associated with a recipient of the goods being delivered by the unmanned air vehicle. The unmanned air vehicle may include a password protected or locket compartment that includes the goods. Using the techniques described herein, the sender of the goods may transmit the password for unlocking the compartment using device 102A and the recipient may decipher the password using device 102B when the unmanned air vehicle lands at his or her location.

Many other applications for devices 102 exist. For instance, in other examples, devices 102 may be part of an authentication process between a computing device and a replacement component or accessory, such as a battery. Using the described techniques, the computing device and battery can exchange scrambled data to verify the authenticity of the battery and a user of the computing device cannot interfere with the authentication process (e.g. to trick the computing device into thinking the battery is genuine even though in actuality the battery may be a counterfeit and potentially dangerous component).

Still in some other examples, devices 102 may be part of an application for protecting a company's proprietary source code available for download (e.g., from the Internet). For example, some source code may only be available for download after a user registers his identity with the company. To protect the identity of the user, the encryption and decryption techniques describe herein may enable the company to keep the user identity confidential; in addition, prior to download, the company may tag the code with a MAC tag that enables the user at his or her device to verify the authenticity of the code after download (e.g., to ensure no malware or other third-party intrusion of the code has occurred).

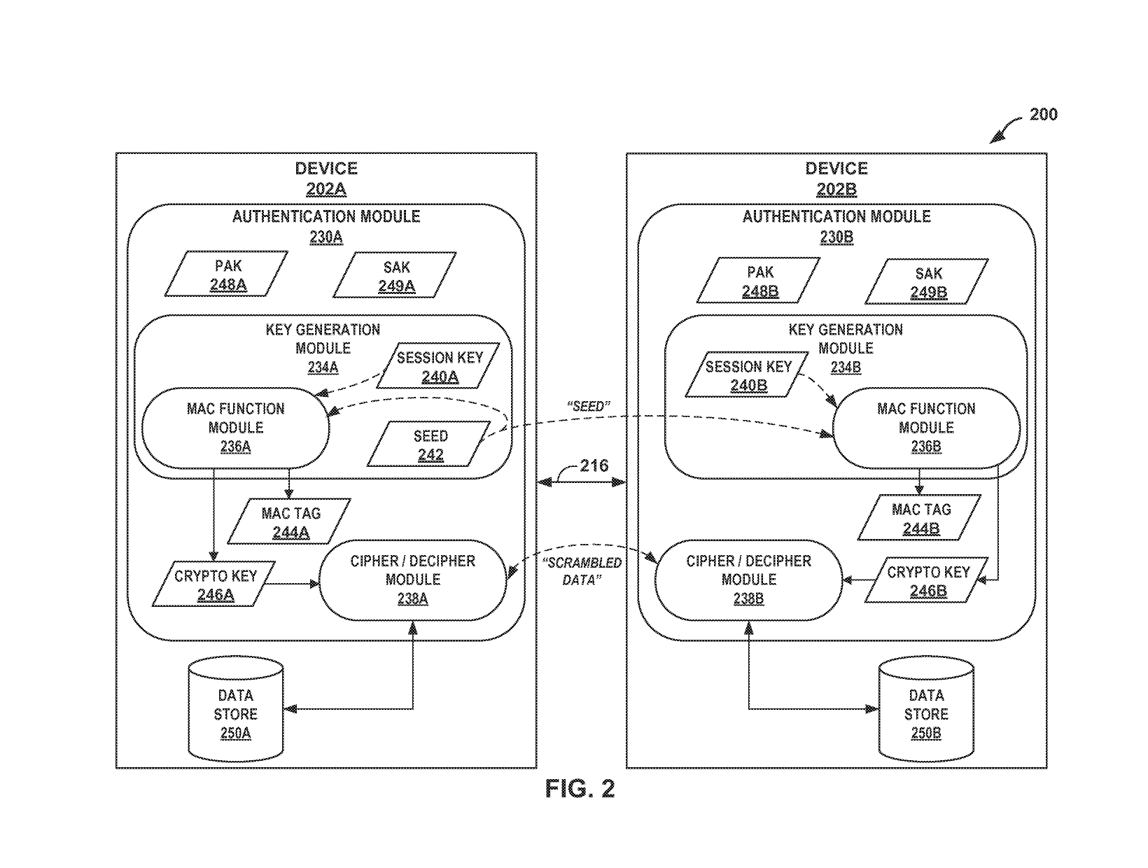

FIG. 2 is a conceptual diagram illustrating system 200 as an additional example system for exchanging encoded data between two authenticated devices 202A and 202B, in accordance with techniques of this disclosure. System 200 includes device 202A and device 202B (collectively “devices 202”). Devices 202 are communicatively coupled via communication channel or link 216. Examples of link 216 include any form of wired or wireless communication medium for exchanging data between two or more devices, such as devices 202. Device 202A include authentication module 230A and data store 250A whereas device 202B include authentication module 230B and data store 250B.

Data store 250A and data store 250B (collectively “data stores 250”) represent any suitable storage medium for storing information before and after transmission across link 216. The information stored at data stores 250A may be accessible by module 230A and the information stored at data stores 250B may be accessible by module 230B. For example, one or more processors of device 202A may execute instructions associated with authentication module 230A that cause module 230A to perform read/write operations at data store 250A to process information before transmission to device 202B or after receipt from device 202B. Similarly, an ASIC of device 202B may perform operations associated with authentication module 230B that cause module 230B to perform read/write operations at data store 250B to process information before transmission to device 202A or after receipt from device 202A.

Authentication modules 230A and 230B (collectively “authentication modules 230”) may enable devices 202 to execute a challenge-response protocol for authenticating devices 202 and ensuring integrity of the data being exchanged over link 216. Authentication modules 230 may use respective instances of a session key derived from the execution of the challenge-response protocol to encode and decode the data being exchanged over link 216. Authentication modules 230 may be implemented using a variety of technologies and in a many different ways. For instance, in some examples, authentication modules 230 include a combination or hardware, software, and/or firmware configured to perform operations described herein for authenticating and encrypting/decrypting data, in some examples, authentication modules 230 present stand-alone integrated circuits or include one or more processors configured to perform operations described herein for authenticating and encrypting/decrypting data. In some examples authentication modules 230 represent individual semiconductor chips and include memory. In some examples, the functionality and features of authentication modules 230 may be implemented as one or more system-on-chip components (e.g., to reduce the size and/or cost of devices 202).

Authentication module 230A includes key generation module 234A and cipher/decipher module 238A. Key generation module 234A includes MAC function module 236A. Authentication module 230B includes key generation module 234B, MAC function module 236B, and cipher/decipher module 238B. Key generation module 234B includes MAC function module 236B.

Key generation module 234A and 234B (collectively “key generation modules 234”) determine, respectively, MAC tags 244A and 244B for authenticating messages passed between devices 202 and also determine, respectively, crypto keys 246A and 246B for ciphering and deciphering the messages.

For authenticating messages passed between devices 202, key generation module 234A may determine session key 240A for generating MAC tag 244A associated with a communication session between device 202A and device 202B and key generation module 234B may determine session key 240B for generating MAC tag 244B associated with the communication session between device 202A and device 202B. Session keys 240A and 240B represent two separate instances of the same session key. MAC tags 244A and 244B represent two separate instances of the same MAC tag. Each of session keys 240A and 240B, and each of MAC tags 244A and 244B, is independently derived, respectively, by key generation modules 234A and 234B.

In some examples, key generation modules 234 derive session keys 240A and 240B as session as a byproduct of a challenge-response protocol. For example, the protocol may utilize elliptic curve asymmetric authentication. An elliptic curve E over a finite field K is the set of solutions (x, y) in K×K of a cubic equation y²+a1xy+a3y=x³+a2x²+a4x+a6 without singular points, where a1, a2, a3, a4, and a6 are elements of the finite field K. Adding the point at infinity O as zero element, the points of the elliptic curve form a finite abelian group. The group law is defined by the algebraic fact that each line through two points P and Q of E intersects the curve at a third not necessarily different point R and the sum P+Q+R=O is the zero element. (If P=Q then the tangent line intersects the curve in R.)

Analogously to vector spaces, the scalar multiplication k*P is defined where k is an integer and P a point of E. Then k*P denotes the k-fold addition of P, For cryptographically strong elliptic curves the scalar multiplication k*P=S is a one-way function, e.g. it is possible to compute k*P in time polynomial in the length of the parameters but given P and S there are only algorithms with exponential running time known for the computation of the scalar k. This one-way function may be the basis for the security of cryptographic protocols using elliptic curves.

For example, to generate MAC tags 244A and to cause device 202B to generate MAC tag 244B (e.g., for authenticating messages passed between devices 202), key generation module 234A may determine a random value λ and use the random value λ to generate a challenge, x_{A} that key generation module 234A sends to key generation module 234B. In some examples, the challenge, x_{A}, includes the affine x-coordinate of a point A on a curve that is the scalar multiple of a base point, P, of a curve represented by its affine x-coordinate, xₚ, with the chosen random value λ. In other embodiments, the challenge may be generated from the random value λ as well as additional data. The challenge, A, represented by x_{A}, may be transmitted from key generation module 234A to key generation module 234B.

At the start of the authentication, device 202A holds public authentication key (PAK) 248A and device 202B holds a corresponding secret authentication key (SAK.) 249B, Conversely, device 202B may hold PAK 248B and device 202A may hold a corresponding SAK 249. Both PAK 248A and SAK 249B form one authentication key pair for authenticating messages when device 202A acts as a host and device 202B acts as a slave, and PAK 248B and SAK 249A form another authentication pair for authenticating messages transmitted hen device 202B acts as a host and device 202A acts as a slave.

Upon receipt of the challenge x_{A}, and in response to receiving the challenge x_{A}, key generation module 234B may generate session key 240B. For example, key generation module 234B may determine projective coordinates X_{B} and Z_{B} for a point B on the curve and then apply a function f to get session key 240B=f (X_{B}, Z_{B}).

More particularly, in some examples, key generation module 234B may determine X_{B} and Z_{B} by function f which is a scalar multiplication of the challenge x_{A} and SAK 249B. Key generation module 234B may select a number of bits for the scalar multiplication, of length L, from one of the coordinates to form session key 240B. In this example, coordinate X_{B} may be used, but in other embodiments Z_{B} can be used instead. The number of bits and therefore the integer Lean also vary in embodiments.

Key generation module 234B may write session key 240B into a register or memory associated with device 202B (e.g. at data store 250B) or some other memory location within authentication module 230B for subsequent data authentications. in some examples, key generation module 234 may regenerate session key 240B for each authentication procedure.

Next, key generation module 234B may apply a function g to the projective coordinates X_{B} and Z_{B} to obtain data w=g(X_{B}, Z_{B}), which is sufficient for key generation module 234A to identify and compute the actual projective representation of the point B used by key generation module 234B. More particularly, in one example, key generation module 234B may call on MAC function module 236 to execute a MAC algorithm that takes the projective coordinate X_{B} and the message data (e.g., information) to be transmitted (MAK) as inputs and outputs MAC Tag 244B as output. In this way, key generation module 234B may determine, based on session key 240B, MAC tag 244B which represents an instance of the MAC tag associated with the communication session.

Authentication module 230B may send MAC tag 244B and projective coordinate Z_{B} (or X_{B} in embodiments in which Z_{B} was used as the source of session key 240B) to key generation module 234A so that key generation module 234A may determine MAC tag 244A and the authenticity of the data being transmitted with MAC tag 244B. In other words, key generation module 234B may call on MAC function module 236B which functions as an authentication stamp of sorts that ensures data exchanged between devices 202 is not manipulated during transmission.

Key generation module 234A may then determine session key 240A. For example, key generation module 234A may calculate, in a first step, the affine coordinate xc of a point C on the curve by a multiplication of the chosen random value λ with the affine x-coordinate of public authentication key 248A as an expected response value. Then, device 202A may apply a function h to the expected response value x_{C} and the data w received from device 202B, resulting in the production of session key 240A=h(x_{C}, w), Accordingly, if authentication between devices 202A and 202B succeeds, session key 240A should at this point equal session key 240B.

More particularly, in one example, device 202A may calculate or has already calculated the affine coordinate x_{C} of a point C on the curve by a multiplication of the chosen random value λ with the affine x-coordinate of PAK 248A. Device 202A may then multiply x_{C} with Z_{B} received from device 202B to determine the projective coordinate X_{B}. Device 202A may next takes L bits from X_{B} to determine session key 240A and writes session key 240A to memory 218 (e.g., RAM, data store 250A, or at some other non-volatile memory of device 202A) for use in subsequent data authentications.

Using session key 240A, device 202A can attempt to authenticate the data previously received via link 216 from device 202B. For example, authentication module 230A may verifying that MAC lag 244A matches MAC lag 244B associated with the data received from device 202B. In subsequent receipts of data between devices 202A and 202B, given that session keys 240A and 240B have already been determined and authenticated, device 202A need only write the data received from device 202B into memory at data store 250.

At some later time, devices 202A and 202B may repeat the authentication process to refresh session keys 240A and 240B (e.g., in order to protect session keys 240A and 240B and maintain authentication). The period of lime between refreshes of session keys may vary, and may be based on the strength of the MAC function or fingerprint operations performed by MAC functions 236A and 236B.

In accordance with techniques of this disclosure, for ciphering and deciphering messages passed between devices 202, key generation module 234A may reuse session key 240A, as determined above, for generating crypto key 246A associated with a communication session between device 202A and device 202B and key generation module 234B may reuse session key 240B, as determined above, for generating crypto key 246B associated with the communication session between device 202A and device 202B.

Crypto keys 246A and 246B represent two separate instances of the same crypto key for coding (e.g., encoding and/or decoding) a message associated with devices 202. Each of crypto keys 246A and 246B is independently derived, respectively, by key generation modules 234A and 234B. By deriving separate instance of the same crypto key, devices 202 can encode and decode data messages without sharing any information across link 216 that may provide clues to a third party attacker for decrypting the data.

In operation, key generation module 234B may determine session key 240B as part of the process key generation module 234B undergoes for generating MAC tag 244B associated with a communication session between device 202B and device 202A. Next, key generation module 234B may determine, based at least in part on session key 244B, crypto key 246B for coding a message bound for device 202A.

Key generation module 234B may generate crypto key 246B using MAC function module 236B. For example, in some instances, authentication module 230B may receive, from authentication module 230A of device 202A, an indication of a seed value N (e.g., a randomly selected number) for determining crypto key 246B and use the seed value N along with session key 244B as inputs to MAC function module 236B for determining crypto key 246B. In the example of FIG. 2, seed value N is shown as “seed 242”.

In some examples, the seed value N is updated to enhance security. For example, the seed value N may never be repeated (e.g., never use the same value twice) and if key generation module 234B determines that the seed value N is the same value used previously, key generation module 234B may request, from authentication module 230A, an updated seed value (e.g., challenge again).

In some examples, the seed value N is not a “random” number but instead may be a “shared secret” that devices 202 each derive independently. For example, the seed value N may be based on some hash of common data (e.g., time, date, etc.) or may be preprogrammed (e.g., by an administrator),

In any case, MAC function module 236B may receive the seed value N as well as projective coordinate X_{B} or some derivation thereof (e.g., session key 240B or some other L bits of projective coordinate X_{B}) and determine crypto key 246B. Also referred to as a stream of Message Cipher Block (MCB), crypto key 246B may be equal to the output of MAC (X_{B}, N).

While key generation module 234B generates crypto key 246B using MAC function module 236B, key generation module 234A of device 202A generates crypto key 246A using MAC function module 236B and seed 242. For example, key generation module 234A may provide session key 240A (or some other derivation of X_{B}) and seed 242 as input into MAC function module 236A to produce as output, crypto key 246A (also referred to as MCB′).

After generating crypto keys 246A and 246B, devices 202 are ready to encode and decode messages. Authentication module 230B may generate a message (also referred to as “Data”) for transmission to device 202A that includes a portion of the data stored at data store 250B. In some examples, the message produced by authentication module 230B includes an indication of the MAC tag associated with the communication session (e.g., MAC tag 244B) and additional information (e.g., proprietary code, command and control functions for an unmanned air vehicle, or other message data needing protection).

Authentication module 230B may rely on cipher/decipher module 238B to encode the message based on crypto key 246B. For example, cipher/decipher module 238B may perform an exclusive-or (XOR) operation between an unencoded portion of the message and crypto key 246B to produce scrambled data as output. For instance, in some examples, cipher/decipher module 238B may produce ciphered data CpData equal to MCB̂Data.

In some examples, rather than the exclusive-or operation, cipher/decipher module 238B may rely on cyclic redundancy check (CRC) operations or hash functions to scramble a message based on crypto key 246B. CRC is an error-detecting code commonly used in digital networks and storage devices to detect accidental changes to raw data. Blocks of data entering these systems get a short check value attached, based on the remainder of a polynomial division of their contents. On retrieval the inverse calculation is performed to determine the unscrambled data. A cryptographic hash function may enable cipher/decipher module 238B to map some combination of crypto key 246B and the message data to a particular hash value. Upon receipt, the original data can be deciphered by performing the inverse hash of the particular hash value. In the example of FIG. 2, cipher/decipher module 238B may receive crypto key 246B and the message data as input and using CRS operations or hash functions, generate scrambled data as output.

After encoding the message based on crypto key 246B, authentication module 230B of device 202B may transmit, to device 202A, the encoded message via link 216. Authentication module 230A of device 202A may receive, from device 202B, the encoded message via link 216. Based on crypto key 246A, authentication module 230A may decode the message received via link 216.

For example, authentication module 230A may provide the encoded message to cipher/decipher module 238A. If an exclusive-or operation was used to encode the message, cipher/decipher module 238A may decode the message based on crypto key 246A by likewise performing the exclusive-or operation between the message and crypto key 246A. Otherwise, if a CRC operation or hash function was used by cipher/decipher module 238B to encode the message received via link 216, cipher/decipher module 238A may decode the message received via link 216 using crypto key 246A and the inverse CRC operation or hash function.

Cipher/decipher module 238A may store the unencoded data at data store 250A for use by other components of device 202. For example, if device 202A is an unmanned air vehicle, a processor or other component of device 202A may provide the unencoded data stored at data store 250A as input to a control function (e.g., for controlling the unmanned air vehicle).

In some examples, subsequent to decoding the message, authentication module 230A may authenticate, based on MAC tag 244A, the message. In other words, before storing the unencoded message data at data store 250A, authentication module 230A may perform authentication operations on an embedded MAC tag found in the data using MAC tag 244A as described above.

For example, authentication module 230A may determine whether MAC tag 244A corresponds to MAC lag 244B (as derived from the unencoded message data received via link 216), In some examples, responsive to determining that MAC tag 244A corresponds to MAC tag 244B, authentication module 230A may determine that the message received via link 216 is authentic. In other words, authentication module 230A may determine that the message received via link 216 actually derived from device 202B and was not altered during transmission (e.g., by a third-party). In some examples, responsive to determining that MAC tag 244A does not correspond to MAC tag 244B, authentication module 230A may determine that the message received via link 216 is not authentic. In other words, authentication module 230A may determine that the message received via link 216 may not have actually derived from device 202B or may have been altered during transmission (e.g., by a third-party, by weather anomalies or other interference associated in the transmission).

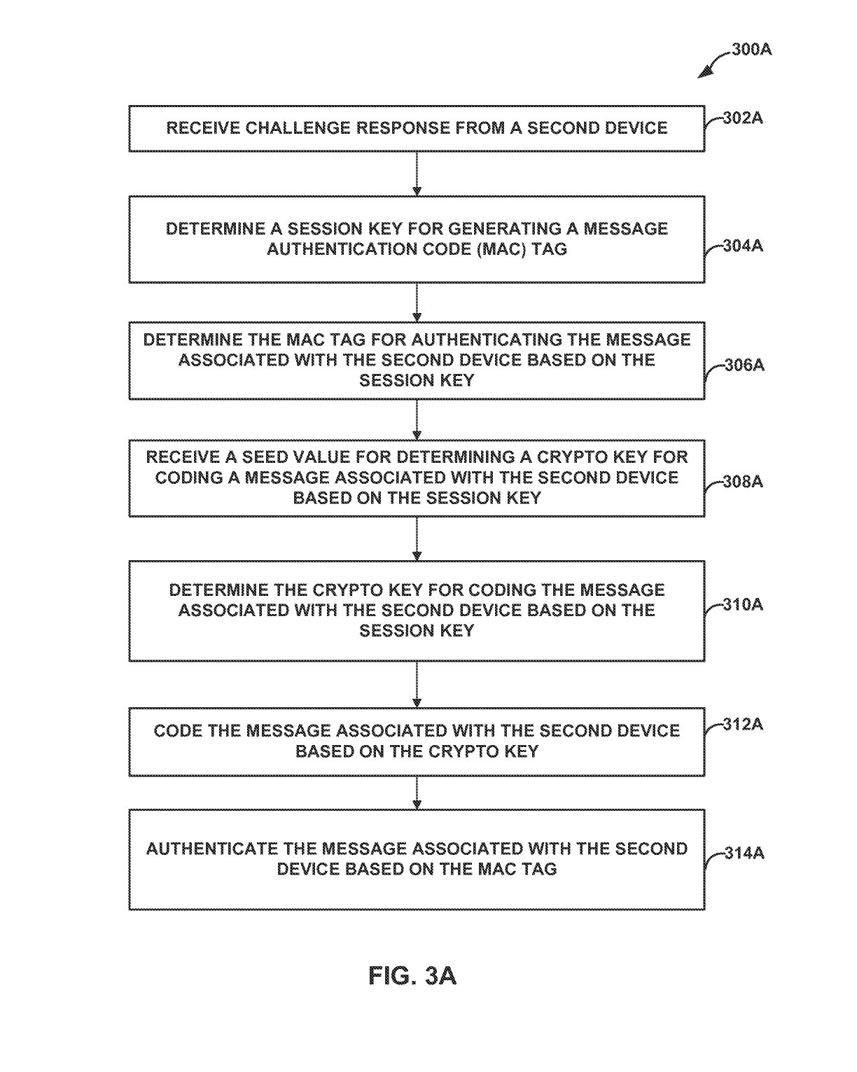

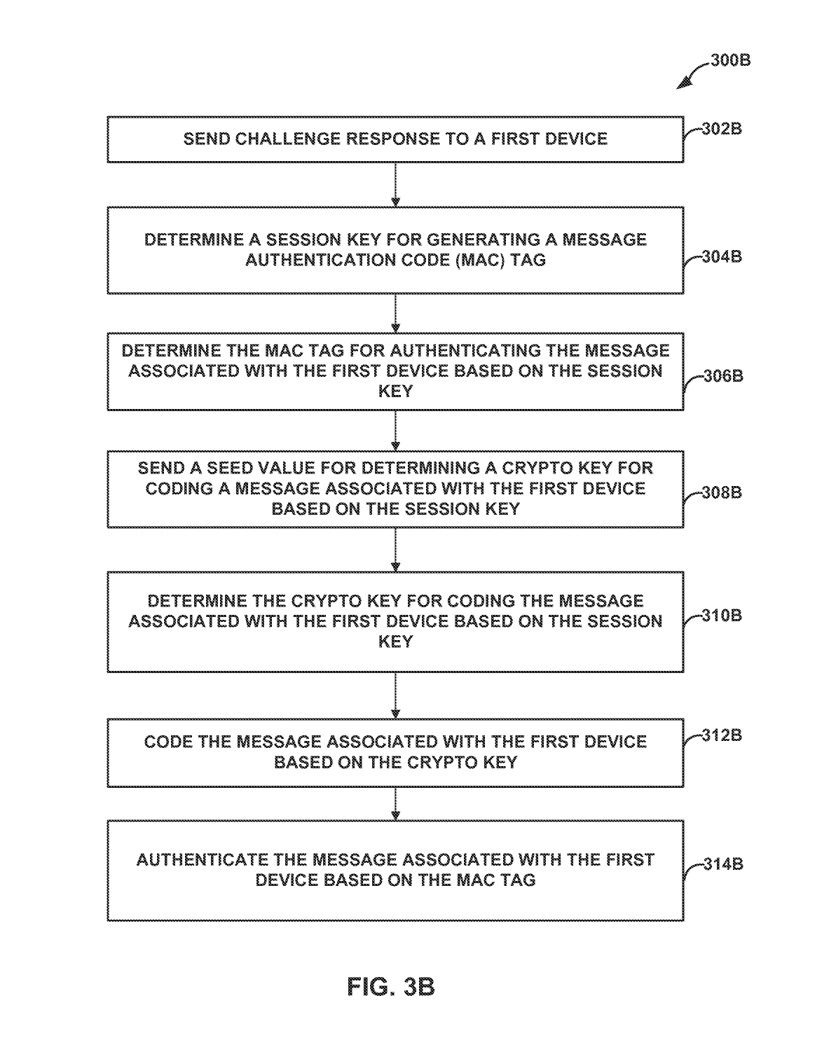

FIGS. 3A and 3B are flow charts illustrating example operations 300A and 300B performed by example devices for coding data, in accordance with one or more aspects of the present disclosure. FIGS, 3A and 3B are described below in the context of system 100 of FIG. 1. For example, at least one processor of device 102A may perform operations 300A and at least one processor of device 102B may perform operations 300B. In other examples, authentication module 130A may include an ASIC configured to perform operations 300A and authentication module 130B may include an ASIC configured to perform operations 300B. Still in other examples, device 102A may include a memory or other non-transitory computer readable storage medium that includes instructions, that, when executed by at least one processor of device 102A, cause the at least one processor to perform operations 300A and device 102B may include a memory or other non-transitory computer readable storage medium that includes instructions, that, when executed by at least one processor of device 102B, cause the at least one processor to perform operations 300B.

Device 102B frilly generate and send a challenge response to device 102A (302B) and device 102A may receive the challenge response from device 102B (302A). For example, device 102A may receive, from device 102B, an initial signal, message, or portion of data via link 116A that indicates challenge, x_{A}, including the affine x-coordinate of a point A on a curve that is the scalar multiple of a base point, P, of a curve represented by its affine x-coordinate, xₚ, with a chosen random value λ. In other embodiments, the challenge may be generated from the random value λ as well as additional data. The challenge, A, represented by x_{A}, may be transmitted from authentication module 130B to authentication module 130A.

Device 102A may determine a session key for generating a message authentication code (MAC) tag (304A). For example, authentication module 130A may determine projective coordinates X_{B} and Z_{B} for a point B on the curve and then apply a function f to get a session key equal to f(X_{B}X_{B}).

Device 102A may determine the MAC tag for authenticating the message associated with device 102B based on the session key (306A). For example, authentication module 130A may input the challenge received from device 102B into a MAC function along with the derived session key, and receive as output a first instance of the MAC tag to be used for authenticating data transferred during the communication session between device 102A and 102B.

Similarly device 102B may determine a session key for generating a message authentication code (MAC) tag (304B). For example, authentication module 130B may determine projective coordinates X_{B} and Z_{B} for a point B on the curve and then apply a function f to gel a session key equal to f(X_{B}, Z_{B}).

Device 102B may determine the MAC tag for authenticating the message associated with device 102A based on the session key (306B). For example, authentication module 130A may input the challenge received from device 102B into a MAC function along with the derived session key, and receive as output a first instance of the MAG tag to be used for authenticating data transferred during the communication session between device 102A and 102B.

Device 102B may send a seed value for determining a crypto key for coding a message associated with device 102A based on the session key (308B) and device 102A may receive the seed value for determining a crypto key for coding a message associated with device 102B based on the session key (308A). For example, device 102A may receive a subsequent message from device 102B that includes a seed value N for inputting into a MAC function that authentication module 130A uses for deriving a first instance of a crypto key shared by devices 102.

Device 102B may determine the crypto key for coding the message associated with device 102A based on the session key (310B) and device 102A may determine the crypto key for coding the message associated with device 102B based on the session key (310A). For example, authentication module 130A may input the seed value received from device 102B along with the previously derived session key into the MAC function (e.g., the session key used previously for determining the MAG tag associated with the communication session).

In some examples, rather than use the seed value received from device 102B, authentication module 130A may derive the seed value based on the session key. For example, authentication module 130A may utilize a hash function that determines the seed value according to EQ. 1:

derived seed (e.g., session key 2)=a*(session key)²+b*(session key) EQ. 1

Using the output from EQ. 1, authentication module 130A may provide the session key and the received or derived seed into the MAC function previously used for determining the MAC lag to determine the crypto key for the current communication session

Device 102A may encode or decode the message associated with device 102B based on the crypto key (312A) and device 102B may encode or decode the message associated with device 102A based on the crypto key (312B). For example, if encoded data is received by device 102A, authentication module 130A may provide the crypto key and the received message data into a decipher module that, in some examples, uses an exclusive-or operation to determine the unencoded data. Conversely, if device 102A is transmitting encoded data to device 102B, authentication module 130A may provide the crypto key and the unencoded message data into a cipher module that, in some examples, uses an exclusive-or operation to determine the encoded data.

Device 102A may authenticate the message associated with device 102B based on the MAC tag (314A) and device 102B may authenticate the message associated with device 102A based on the MAC tag (314B). For example, when transmitting encoded messages to device 102B, device 102A may append the MAC tag derived for this particular communication session to the encoded message stream so that device 102B can perform authentication techniques for verifying the integrity of the data. In some examples, the MAC tag is encoded or otherwise scrambled in the encoded data. In other examples, the MAC tag is not scrambled. Conversely, when receiving encoded messages that need deciphering, device 102A may compare the MAC tag embedded in, or appended to, the encoded data to determine whether the MAC tag that device 102A derived above, matches the MAC tag received with the data, if the MAC tags match, device 102A may determine that the encoded data received from device 102B is authentic (e.g., meaning the data actually originated from device 102B and was unaltered by a third-party during transmission).

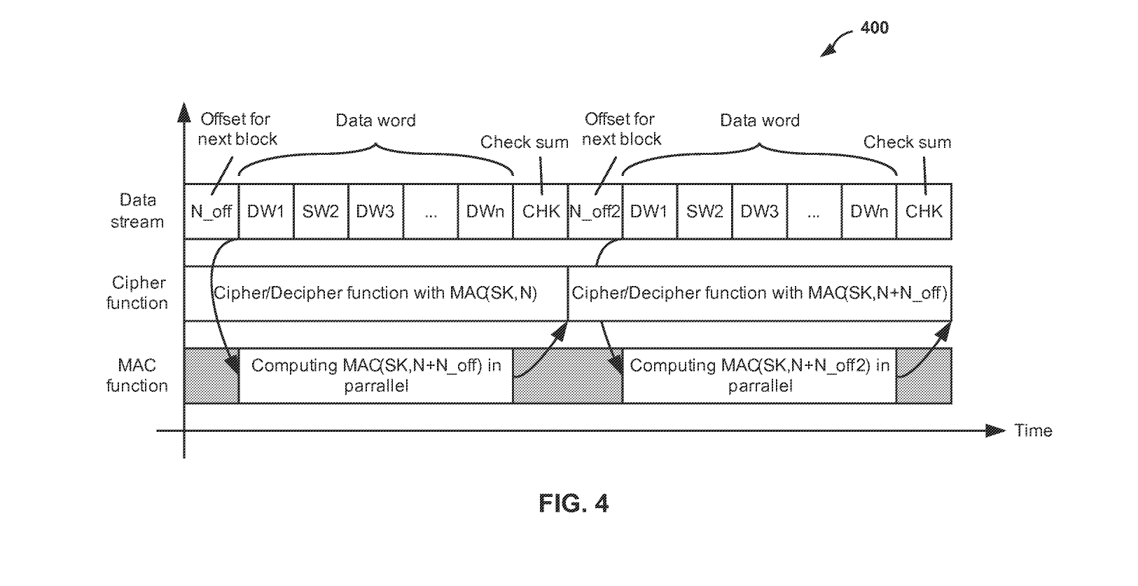

FIG. 4 is a conceptual diagram illustrating example data stream 400 transferred between two authenticated devices, in accordance with one or more aspects of the present disclosure. FIG. 4 is described below in the context of system 100 of FIG. 1.

FIG. 4 shows an offset being chained into a message by an authentication module, such as authentication modules 130 of devices 102, for generating the next message cipher block or crypto key to be used during a subsequent message. For example, after a period of time has elapsed since generating a current crypto key, after a certain amount of encoded data has been transferred between devices 102 using the current crypto key, after the current crypto key has been compromised, or after the current crypto key has otherwise been exhausted, devices 102 may include a newly generated message cipher block to enable continuous data parsing.

In some techniques for performing data integrity checks, a checksum can be appended to a data stream for checking whether the data has been altered from its original form. FIG. 4 shows that as an extension to long data stream, a Iasi data word or byte can be affixed as the first data with an nonce offset, N_off, so that a next Message Cipher Block (crypto key) MCB(m) can be determined by devices 102 as MAC (X_{B}N+N_off) where MCB(m) defines a plurality of MCB. In addition, FIG. 4 shows that the bit location of the data that represents the X_{B} value and the seed value N can be scrambled in the data stream, for instance, using a common secret or by adding a common secret to X_{B} and/or N or in other examples, as a function of N and N_off method.

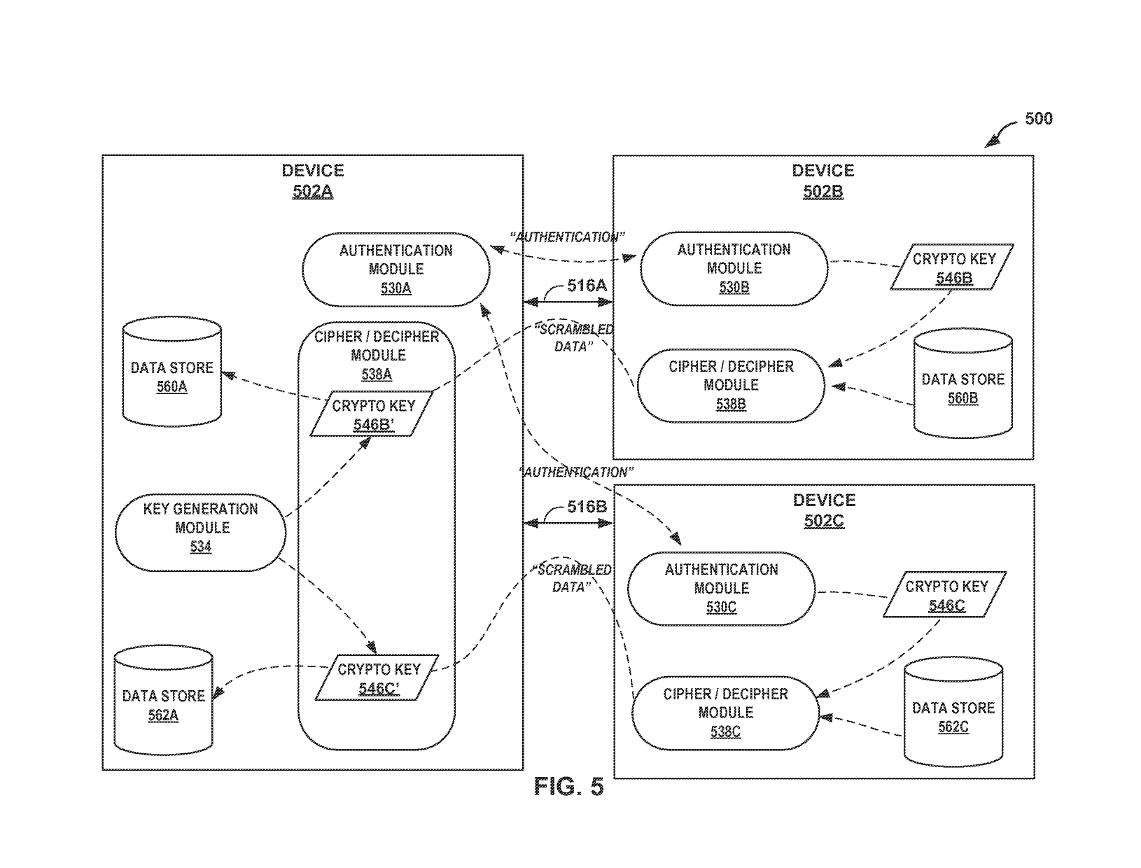

FIG. 5 is a conceptual diagram illustrating system 500 as an additional example system for exchanging encoded data between devices 502A-502C (collectively “devices 502”), where device 502A is a single host device and devices 502B and 502C are two separate slave devices, in accordance with techniques of this disclosure. Devices 502A 502C are similar to devices 102 and 202 of FIGS. 1 and 2. In the example of FIG. 5, device 502A is configured as a host device and devices 502B and 502C are configured as separate slave devices.

Devices 502 include respective authentication modules 530A-530C and respective cipher/decipher modules 538A-538C. Device 502A further includes key generation module 534 and data stores 560A and 562A. Device 502B includes data store 560B and device 502C includes data store 560C. After devices 502A and 502B exchange encoded data via links 516A, the information contained in data store 560A corresponds to the information contained in data store 560B. Similarly, the information contained in data store 562A corresponds to the information stored at data store 562C following an information exchange between devices 502A and 502C via link 516B.

In the example of FIG. 5, devices 502A and 502B share a first set of crypto keys 546B and 546B′ based on a first set of (X_{B}, X_{B}′) and devices 502A and 502C share a second set of crypto keys 546C and 546C′ based on a second set of (X_{B2}, X_{B2}′). In other words, in the example of FIG. 5, device 502A, acting as host of system 500, may share separate crypto key pairs with devices 502B and slave device 502C. IN this way, device 502A can maintain independent, secure communication session over links 516A and 516B.

In other examples, devices 502A and 502B may share two separate sets of crypto keys. The first set of crypto keys 546B and 546B′ based on a first set of (X_{B}, X_{B2}′) may be used when device 502A is transmitting data to device 502B. The second set of crypto keys may be based on a second set of (X_{B}, X_{B}′) and may be used when device 502B is transmitting data to device 502A. In this way, devices 502A and 502B may use different crypto keys depending on which device is transmitting and which is receiving.

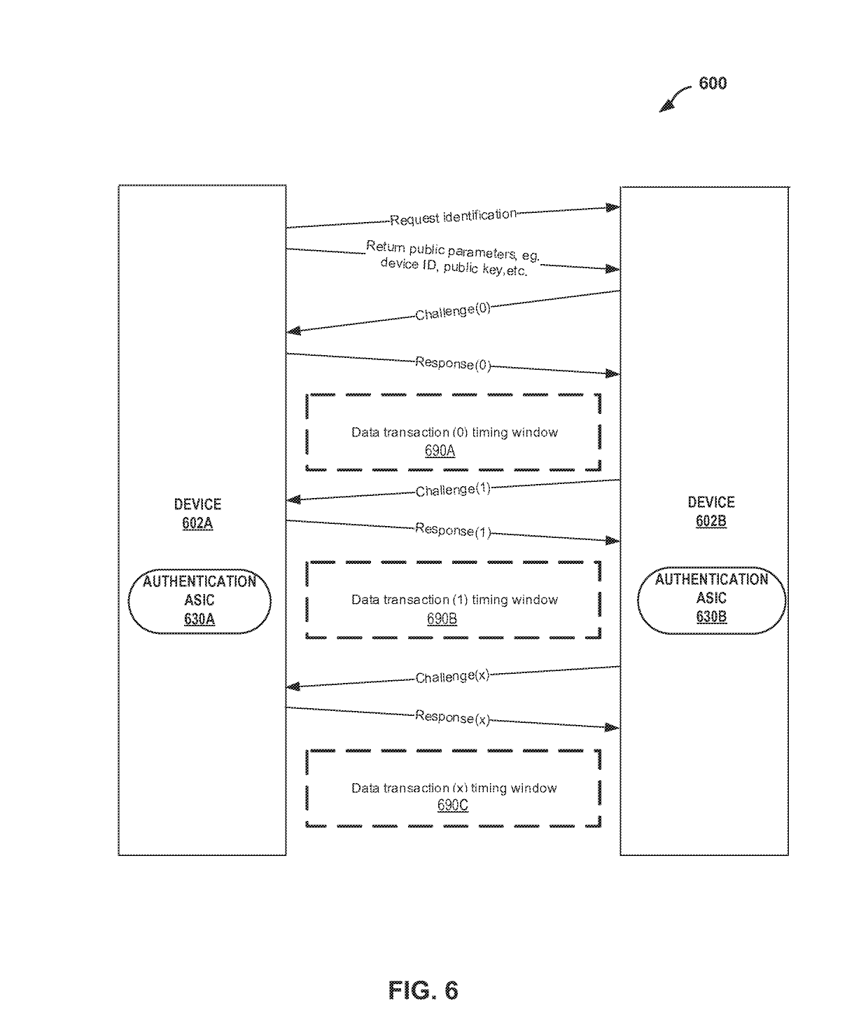

FIG. 6 is a conceptual diagram illustrating authentication flow for exchanging encoded data between devices 602A and 602B of system 600 as examples of two authenticated devices, in accordance with techniques of this disclosure. Device 602A includes authentication ASIC 630A and device 602B includes authentication ASIC 630B. Authentication ASICs 630A and 630B are ASICs that perform operations similar to those operations performed by authentication modules 130 of FIG. 1.

In the example of FIG. 6, device 602B acts as a host and includes a public key. Using the techniques described above with respect to elliptic curve computation, authentication module 630B may generate a challenge based on the public key and transmit the challenge to slave device 602A. This challenge may be a “plaintext” or “encoded” challenge. After a successful authentication between devices 602A and 602B based on the challenge, devices 602A and 602B exchange encoded data during data transaction timing window 690A. FIG. 6 shows that subsequent challenges are generated for subsequent data transaction timing windows 690B and 690C.

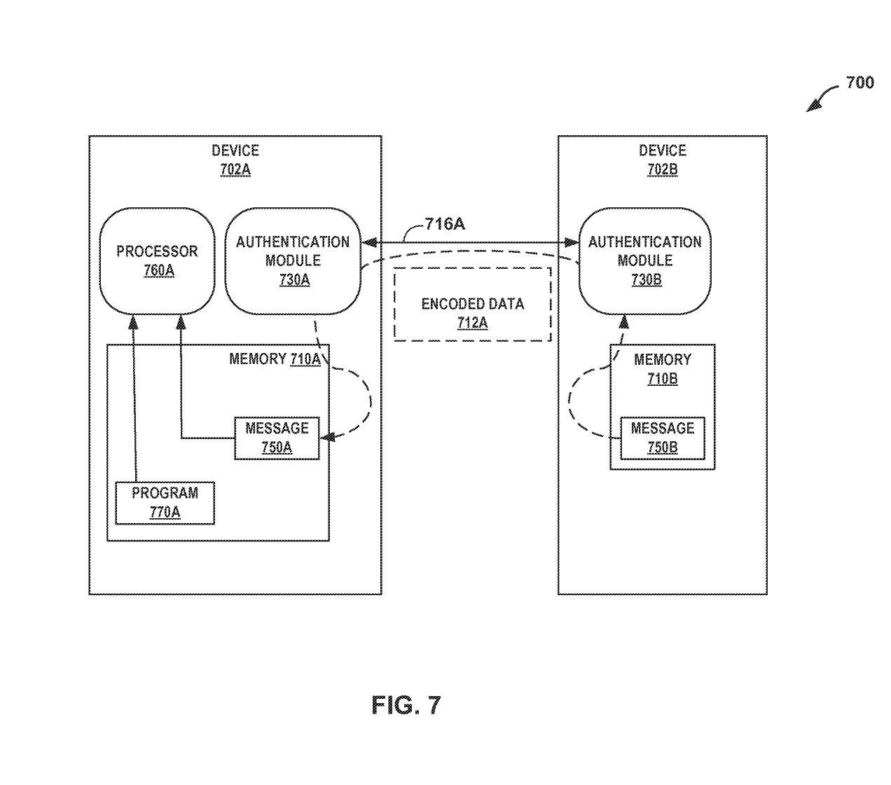

FIG. 7 is a conceptual diagram illustrating system 700 for exchanging encoded data between two authenticated devices 702A and 702B, in accordance with techniques of this disclosure. System 700 includes device 702A in communication over link 716A with device 702B. Devices 702A and 702B may exchange encoded data 712A via link 716A, in accordance with techniques of the present disclosure. Device 702A includes processor 760A, authentication module 730A, and memory 710A which includes program 770A and message 750A. Device 702B includes authentication module 730B, memory 710B, and message 750B.

In some examples, device 702A may be a host device that challenges device 702B. In other examples, device 702A may respond to a challenge from device 702B. In any case, device 702B may send message 750B as encoded data 712A to device 702A which stores encoded data 712A as message 750A.

Upon receipt of message 750A, device 702A may use message 750A for executing program 770A. For example, device 702A may execute instructions associated with program 770A using processor 760A. During execution of program 770A at processor 760A, device 702A may rely on information contained within message 750A to complete execution of program 770A.

In sonic examples, device 702A may replace message 750A with different and unique information based on a subsequent message 750B that is received when a different device 702B is connected to link 716A, During execution of program 770A, device 702A may rely on information contained in message 750A for indexing during execution of a part of program 770A. In other examples, device 702A may rely on information contained in message 750A for determining a value of a parameter for a mathematic calculation or control function executed as part of the execution of program 770A. In sonic examples, the information contained in message 750A is accessable by processor 760A in a secure manner such that the message cannot be replicated in other memory locations of device 702A. On some examples, device 702A may determine when a connection between device 702A and 702B terminates and in response to terminating the connection with device 702B, device 702B may remove message 750A from memory 710A.

In some examples, program 770A represents a control algorithm and message 750A includes a value of a parameter required to execute the control algorithm. For instance, device 702A may be a vehicle (e.g., a UAV) and device 702B may be a payload or other interchangeable component of the vehicle. Device 702A may execute program 770A as a control algorithm differently depending on the specific device 702B. For example, one version of device 702B may have a size or weight dimension that is different than other versions of device 702B. When device 702B is coupled to device 702A via link 716A, device 702A can learn of the size or weight dimension via message 750A and adjust the control of device 702A accordingly.

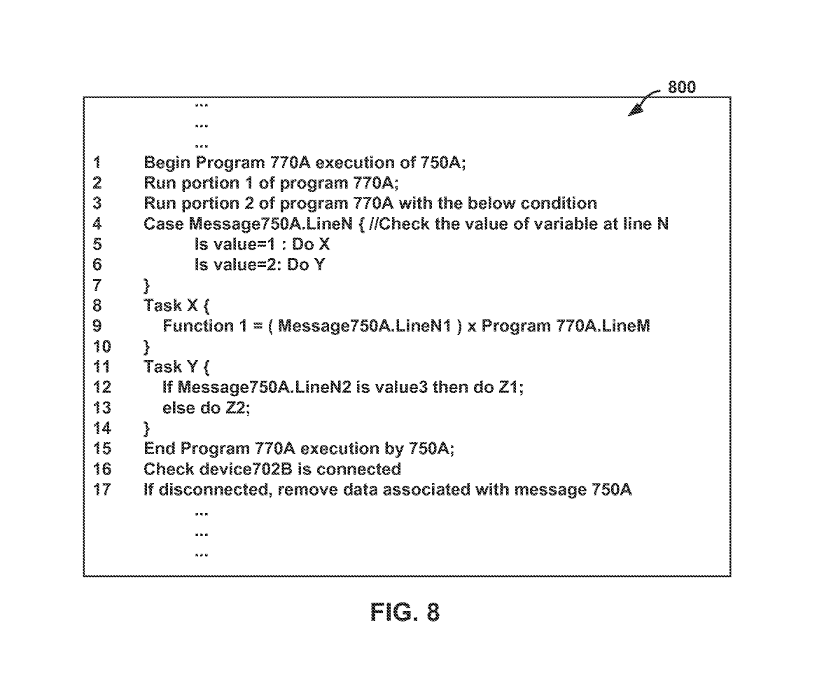

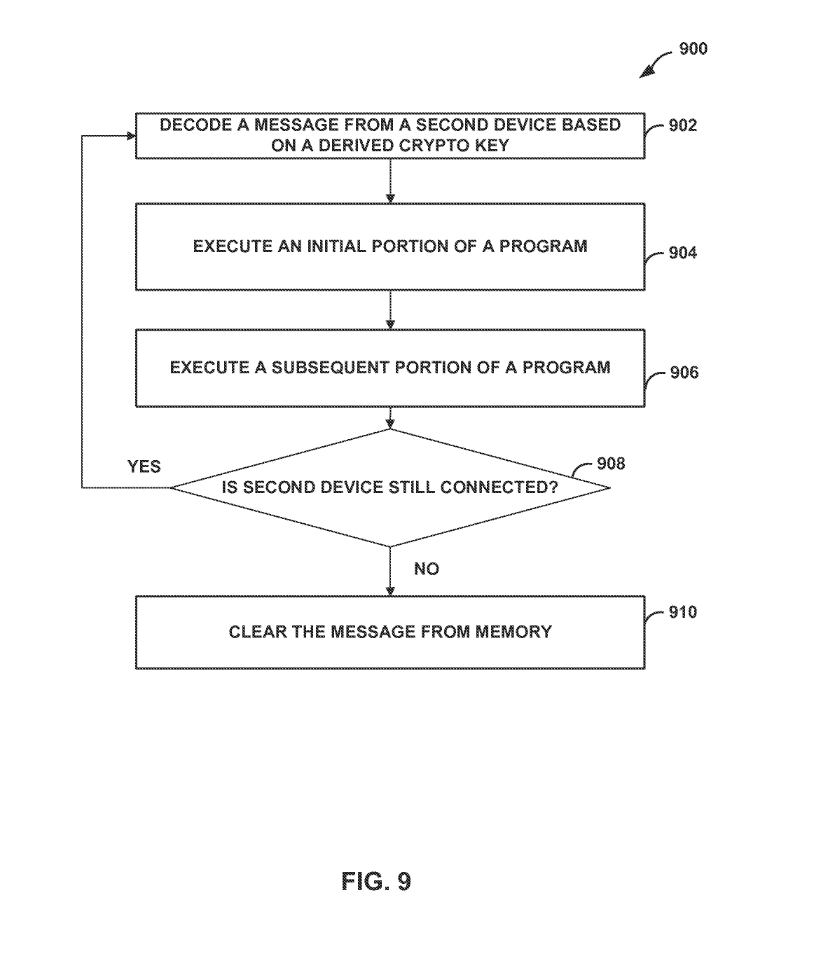

FIG. 8 is a conceptual diagram illustrating example pseudo code 800 for execution by device 702A of FIG. 7 to perform operations for coding data, in accordance with one or more aspects of the present disclosure. In the example of FIG. 8, program 770A represents a “master” or “main” program and information contained in message 750A may be required to complete execution of program 770A. In other examples however, message 750A may itself be a master or main program and program 770A may actually be information required to complete execution of message 750A. As shown in FIG. 8, pseudo code 800 is divided, in no particular order, into lines or instructions 1-17. Pseudo code 800 is described in greater detail within the context of operations 900 of FIG. 9, Device 702A may store pseudo code 800 in compiled or pre-compiled form at memory 710A.

FIG. 9 is a flow chart illustrating example operations 900 for coding data performed by device 702A of FIG. 7 when executing pseudo code 800 of FIG. 8, in accordance with one or more aspects of the present disclosure. Processor 760A and authentication module 730A of device 702A of FIG. 7 may be operable to perform operations 900.

In the example of FIG. 9, device 702A may decode a message from second device based on a derived crypto key (902). For example, authentication module 730A of device 702A may perform operations similar to operations 302A-312A from FIG. 3 to establish a secure communication session with device 702B, derive a crypto key for decoding encoded data 712A, with the derived crypto key, decode encoded data 712A into message 750A.

In some examples, message 750A may include information used by program 770A executing at device 702A to perform a task. For example, program 770A may be a control algorithm for controlling movement of device 702A and message 750A may elude a parameter value associated with device 702B that program 770A needs to control the movement of device 702A.

In some examples, message 750A may include information that is required by program 770A executing at device 702A to complete the task. For example, message 750A may include a critical parameter value or set of instructions that program 770A needs in order to execute at device 702A.

In any case, after decoding encoded data 712A into message 750A, authentication module 730A may store the decoded data at memory 710A. Processor 760A may retrieve instructions for executing program 770A from memory 710A and execute an initial portion of program 770A (904) For example, the initial portion of program 770A may include the instructions on lines 1 and 2 of pseudo code 800.

Processor 760A may retrieve further instructions for executing program 770A from memory 710A and execute a subsequent portion of program 770A (906), For example, the subsequent portion of program 770A may include the instructions on lines 3-15 of pseudo code 800.

In executing the subsequent portion of program 770A, processor 760A may rely on data associated with message 750A. For instance, when executing the instructions on lines 4-7 of code 800, processor 760A may evaluate a case statement based on a value of a variable stored at line N of message 750A. In other words, linen of message 750A may include data that indicates the value of the variable needed by processor 760A to complete execution of code 800.

In further executing the subsequent portion of program 770A, processor 760A may rely on additional data associated with message 750A to complete tasks X and Y. For instance, when executing the instructions on lines 8-10 of code 800 for completing task X, processor 760A may perform a first function (e.g., completing a mathematical operation, logical operation, arithmetic operation, or some other operation) that depends on a value of a variable stored at line N1 of message 750A and a value of a variable stored by program 770A. And when executing the instructions on lines 11-14 of code 800 for completing task Y, processor 760A may perform a second function (e.g., a conditional operation or some other operation) that depends on a value of a variable stored at line N2 of message 750A.

Upon completion of execution of the subsequent portion of program 770A processor 760A may evaluate whether message 750A should or should not be purged from memory (e.g., for security). Processor 760A may determine whether device 702B is still connected (908) to link 716A. For example, Processor 760A may execute line 16 of code 800. Device 702A may detect the removal of device 702B by detecting an electrical connection breakage associated with link 716A, after a timeout, or in response to receiving a subsequent challenge/response for performing authentication (e.g., from the same device 702B or from a different or new device 702B).

If device 702B is still connected, processor 760A may repeat operations 902-906 for executing program 770A and coding data 712A. Otherwise, if communication between device 702B and device 702A is lost or otherwise terminates, processor 760A may execute line 17 of code 800 and perform a remove, clear, or erase operation at the portion of memory 710A that stores message 750A. Processor 760A may clear message 750A fro mil memory 710A (910). By removing message 750A from memory, device 702A may further ensure security of the data associated with message 750A.

Although FIG. 8 is described above with the assumption that message 750A includes data that is part of program 770, in other examples, message 750A may be a program for execution at processor 760A using data associated with program 770A. In other words, device 702B may send a program as encoded data 712 to device 702A and device 702A may execute the program received from device 702B using data previously stored at memory 710.

In this way, two devices can code data in accordance with the techniques described herein in such a way that protects against illicit snooping without having to execute complex cryptographic algorithms or perform complicated operations to first encode data before transmission and subsequently decode the data upon receipt. By producing crypto keys to encode and decode data based at least in part on session keys that were already being derived for authentication purposes, the techniques described in this disclosure may enable low-cost or less complicated systems to exchange information without being susceptible to snooping. The techniques require fewer operations to be performed to implement a secure communication scheme than the number of operations typically required to be performed by other systems that rely on complex cryptographic algorithms. By executing fewer operations, devices in accordance with the described techniques may consume less electrical power and therefore operate more efficiently than other systems.

Clause 1. A method comprising: determining, by a first device, a session key for generating a message authentication code (MAC) tag associated with a communication session between the first device and a second device; determining, by the first device, based at least in part on the session key, a crypto key for coding a message associated with the second device: and coding, by the first device, based on the crypto key, the message.

Clause 2. The method of clause 1, wherein coding the message comprises at least one of: encoding, by the first device, based on the crypto key, the message; or decoding, by the first device, based on the crypto key, the message.

Clause 3. The method of any of clauses 1-2, further comprising: determining, by the first device, based on the session key, an instance of the MAC tag associated with the communication session; and prior to encoding the message, generating, by the first device, based on the MAC tag associated with the communication session, the message.

Clause 4. The method of clause 3, further comprising: generating, by the first device, the message, wherein the message includes an indication of the MAC tag associated with the communication session and additional information.

Clause 5. The method of any of clauses 1-4, further comprising: after encoding the message based on the crypto key, transmitting, by the first device, to the second device, the message.

Clause 6. The method of any of clauses 1-5, further comprising: receiving, by the first device, from the second device, the message; and subsequent decoding the message based on the crypto key, storing, by the first device, information contained in the message.

Clause 7. The method of any of clauses 1-6, further comprising: determining, by the first device, based on the session key, an instance of the MAC tag associated with the communication session; receiving, by the first device, from the second device, the message; and subsequent to decoding the message, authenticating, by the first device, based on the MAC tag associated with the communication session, the message.

Clause 8. The method of clause 7, wherein the instance of the MAC tag associated with the communication session is a first instance of the MAC tag associated with the communication session, the further comprising: determining, by the first device, based on the message, a second instance of the MAC tag associated with the communication session, wherein authenticating the message includes determining whether the first instance of the MAC tag associated with the communication session corresponds to the second instance of the MAC tag associated with the communication session.

Clause 9. The method of clause 8, further comprising: responsive to determining that the first instance of the MAC tag associated with the communication session corresponds to the second instance of the MAC tag associated with the communication session, determining, by the first device, that the message received from the second device is authentic; and responsive to determining that the first instance of the MAC tag associated with the communication session does not correspond to the second instance of the MAC tag associated with the communication session, determining, by the first device, that the message received from the second device is not authentic.

Clause 10. The method of any of clauses 1-9, wherein: encoding the message based on the crypto key comprises performing an exclusive-or operation between an unencoded portion of the message and the crypto key; and decoding the message based on the crypto key comprises performing the exclusive-or operation between an encoded portion of the message and the crypto key.

Clause 11. The method of any of clauses 1-10, further comprising: receiving, by the first device, from the second device, an indication of a seed value for determining the crypto key, wherein the crypto key is determined further based at least in part on the seed value.

Clause 12, The method of any of clauses 1-11, wherein: the session key is a first session key, the first session key is determined by at least receiving, by the first device, from the second device, the first session key, wherein the first session key is generated by at least one processor of the second device, the message is coded by at least decoding, with at least one processor of the first device, the message with the first session key, and the method further comprising; processing, by the first device, the message, wherein processing the message includes modifying at least a portion of information contained in the message; encoding, by the first device, the processed message with a different session key generated by the at least one processor of the second device; and outputting, by the first device, to the second device, the processed message.

Clause 13. The method of any of clauses 1-12, wherein the message comprises information used by a program executing at the first device to perform a task.

Clause 14. The method of clause 13, wherein the information is required by the program executing at the first device to complete the task.

Clause 15, The method of any of clauses 13-14, wherein the message is a first message from a plurality of messages that each include information used by a program executing at the first device to perform a task.

Clause 16. The method of clause 15, further comprising: executing, by the first device, the program in response to decoding the message based on the crypto key.

Clause 17. The method of any of clauses 13-16, further comprising: responsive to determining that the communication session between the first device and the second device ended, removing, by the first device, from a memory of the first device, the message.

Clause 18. A first device comprising at least one processor operable to: determine a session key for generating a message authentication code (MAC) tag associated with a communication session between the first device and a second device; determine, based at least in part on the session key, a crypto key for encoding or decoding a message associated with the second device; and code, based on the crypto key, the message.

Clause 19. The first device of clause 18, wherein the at least one processor is further operable to: determine, based on the session key, an instance of the MAC lag associated with the communication session; and prior to encoding the message, generate, based on the MAC tag associated with the communication session, the message.

Clause 20. The first device of clause 19, wherein the at least one processor is further operable to generate the message, wherein the message includes an indication of the MAC tag associated with the communication session and additional information.

Clause 21. The first device of any of clauses 18-20, wherein the at least one processor is further operable to after encoding the message based on the crypto key, transmit, to the second device, the message.

Clause 22, The first device of any of clauses 18-21, wherein the at least one processor is further operable to: receive, from the second device, the message; and subsequent decoding the message based on the crypto key, store, information contained in the message.

Clause 23. The first device of any of clauses 18-22, wherein the at least one processor is further operable to: determine, based on the session key, an instance of the MAC tag associated with the communication session; receive, from the second device, the message; and subsequent to decoding the message, authenticate, based on the MAC tag associated with the communication session, the message.

Clause 24. The first device of any of clauses 18-23, wherein the at least one processor comprises an application specific integrated circuit (ASIC).

Clause 25. The first device of any of clauses 18-24, wherein the first device and the second device comprise an unmanned air vehicle and a control device configured to control the unmanned air vehicle.

Clause 26. A system comprising: means for determining a session key for generating a message authentication code (MAC) tag associated with a communication session between a first device and a second device; means for determining, based at least in part on the session key, a crypto key for encoding or decoding a message associated with the second device; and means for coding, based on the crypto key, the message.

In one of more examples, the operations describe(may be implemented in hardware, software, firmware, or any combination thereof. If implemented in software, the operations may be stored on or transmitted over, as one or more instructions or code, a computer-readable medium and executed by a hardware-based processing unit. Computer-readable media may include computer-readable storage media which corresponds to a tangible medium such as data storage media, or communication media including any medium that facilitates transfer of a computer program from one place to another, e.g., according to a communication protocol. In this manner, computer readable media generally may correspond to (1) tangible computer-readable storage media, which is non-transitory or (2) a communication medium such as a signal or carrier wave, Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers, Combinations of the above should also be included within the scope of computer-readable media.

Instructions may be executed by one or more processors, such as one or more DSPs, general purpose microprocessors, ASICs, FPGAs, or other equivalent or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or More circuits or logic elements.

The techniques of this disclosure may be implemented in a wide variety of devices or apparatuses, including an alternator, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
determining, by a first device, a session key for generating a message authentication code (MAC) tag associated with a communication session between the first device and a second device;
determining, by the first device, based at least in part on the session key, a crypto key for coding a message associated with the second device; and
coding, by the first device, based on the crypto key, the message.

2. The method of claim 1, wherein coding the message comprises at least one of:
encoding, by the first device, based on the crypto key, the message; or decoding, by the first device, based on the crypto key, the message.

3. The method of claim 1, further comprising:
determining, by the first device, based on the session key, an instance of the MAC tag associated with the communication session; and
prior to encoding the message, generating, by the first device based on the MAC tag associated with the communication session, the message.

4. The method of claim 3, further comprising:
generating, by the first device, the message, wherein the message in an indication of the MAC tag associated with the communication session and additional information.

5. The method of claim 1 further comprising:
after encoding the message based on the crypto key, transmitting, by the first device, to the second device, the message.

6. The method of claim 1, further comprising:
receiving, by the first device, from the second device, the message; and
subsequent decoding the message based on the crypto key, storing, by the first device, information contained in the message.

7. The method of claim 1, further comprising:
determining, by the first device, based on the session key, an instance of the MAC tag associated with the communication session;
receiving, by the first device, from the second device, the message; and
subsequent to decoding the message, authenticating, by the first device, based on the MAC tag associated with the communication session, the message.

8. The method of claim 7, wherein the instance of the MAC lag associated with the communication session is a first instance of the MAC tag associated with the communication session, the further comprising:
determining, by the first device, based on the message, a second instance of the MAC tag associated with the communication session, wherein authenticating the message includes determining whether the first instance of the MAC tag associated with the communication session corresponds to the second instance of the MAC tag associated with the communication session.

9. The method of claim 8, further comprising:
responsive to determining that the first instance of the MAC tag associated with the communication session corresponds to the second instance of the MAC tag associated with the communication session, determining, by the first device, that the message received from the second device is authentic; and
responsive to determining that the first instance of the MAC tag associated with the communication session does not correspond to the second instance of the MAC tag associated with the communication session, determining, by the first device, that the message received from the second device is not authentic.

10. The method of claim 1, wherein:
encoding the message based on the crypto key comprises performing an exclusive-or operation between an unencoded portion of the message and the crypto key; and
decoding the message based on the crypto key comprises performing the exclusive-or operation between an encoded portion of the message and the crypto key.

11. The method of claim 1, further comprising:
receiving, by the first device, from the second device, an indication of a seed value for determining the crypto key, wherein the crypto key is determined further based at least in part on the seed value.

12. The method of claim 1, wherein:
the session key is a first session key,
the first session key is determined by at least receiving, by the first device, from the second device, the first session key, wherein the first session key is generated by at least one processor of the second device,
the message is coded by at least decoding, with at least one processor of the first device, the message with the first session key, and
the method further comprising:
processing, by the first device, the message, wherein processing the message includes modifying at least a portion of information contained in the message;
encoding, by the first device, the processed message with a different session key generated by the at least one processor of the second device; and
outputting, by the first device, to the second device, the processed message.

13. The method of claim 1, wherein the message comprises information used by a program executing at the first device to perform a task.

14. The method of claim 13, wherein the information is required by the program executing at the first device to complete the task.

15. The method of claim 13, wherein the message is a first message from a plurality of messages that each include information used by a program executing at the first device to perform a task.

16. The method of claim 15, further comprising:
executing, by the first device, the program in response to decoding the message based on the crypto key.

17. The method of claim 13, further comprising:
responsive to determining that the communication session between the first device and the second device ended, clearing, by the first device, from a memory of the first device, the message.

18. A first device comprising at least one processor operable to:
determine a session key for generating a message authentication code (MAC) tag associated with a communication session between the first device and a second device;
determine, based at least in part on the session key, a crypto key for encoding or decoding a message associated with the second device; and
code, based on the crypto key, the message.

19. The first device of claim 18, wherein the at least one processor is further operable to:
determine, based on the session key, an instance of the MAC lag associated with the communication session; and
prior to encoding the message, generate, based on the MAC tag associated with the communication session, the message.

20. The first device of claim 19, wherein the at least one processor is further operable to generate the message, wherein the message includes an indication of the MAC tag associated with the communication session and additional information.

21. The first device of claim IS, wherein the at least one processor is further operable to after encoding the message based on the crypto key, transmit, to the second device, the message.

22. The first device of claim 18, wherein the at least one processor is further operable to:
receive, from the second device, the message; and
subsequent decoding the message based on the crypto key, store, information contained in the message.

23. The first device of claim 18, wherein the at least one processor is further operable to:
determine, based on the session key, an instance of the MAC tag associated with the communication session;
receive, from the second device, the message; and
subsequent to decoding the message, authenticate, based on the MAC tag associated with the communication session, the message. 24, The first device of claim 18, wherein the at least one processor comprises an application specific integrated circuit (ASIC).

25. The first device of claim 18, wherein the first device and the second device comprise an unmanned air vehicle and a control device configured to control the unmanned air vehicle.

26. A system comprising:
means for determining a session key for generating a message authentication code (MAC) tag associated with a communication session between a first device and a second device;
means for determining, based at least in part on the session key, a crypto key for encoding or decoding a message associated with the second device; and
means for coding, based on the crypto key, the message.
